(19) United States
(12) Patent Application Publication
(10) Pub. No.: US 2015/0371248 A1
(43) Pub. Date: Dec. 24, 2015

(54) SYSTEMS AND METHODS FOR DETERMINING SALES MIGRATION BETWEEN MERCHANT TYPES

(71) Applicant: MasterCard International Incorporated, Purchase, NY (US)

(72) Inventor: Debashis Ghosh, Charlotte, NC (US)

(21) Appl. No.: 14/313,609

(22) Filed: Jun. 24, 2014

(51) Int. Cl. G06Q 30/02

(52) U.S. Cl. CPC G06Q 30/0205

(57) ABSTRACT

A method and system for determining sales migration between merchant types using a payment card network are provided. The method includes storing in a memory device, financial transaction data records for a plurality of purchase transactions conducted between a plurality of merchants and a plurality of payment card cardholders over a predetermined period of time. Each of the financial transaction data records including a cardholder account number and a merchant identifier. The method further includes determining a geographic home purchasing location of at least some of the plurality of the payment card cardholders using a respective cardholder account number and determining a geographic location of at least some of the plurality of merchants using a respective merchant identifier. The method also includes determining a trend of purchases from selected geographic home purchasing locations in relation to selected merchant identifiers and outputting the determined trends.

### BACKGROUND

This disclosure relates generally to processing raw data and, more particularly, to computer systems and computer-based methods for determining sales migration between merchant types.

Brick and mortar retail stores compete with online stores for customers and sales. Each type of store offers their own advantages and disadvantages. Many brick and mortar retail stores have opened their own online stores to counter the competition of online stores such as Amazon.com®. The ability to determine a rate at which customers switch their buying patterns from brick and mortar stores to online stores is important to the brick and mortar retailers for their ongoing success. Even with the intra-store transference of sales from brick and mortar to its online stores, it is important to understand where the customers are located and how the buying trends are changing. Large online retailers skew customer location data because customers from a wide ranging territory, such as the entire USA, appear as all being concentrated in a single location, such as, for example, Seattle, Wash., where Amazon.com® is located. Much more meaningful location data could be made available if the residential areas of those customers of Amazon.com® could be determined and attributed to their own home area. This localized customer information could then be compared to sales at local brick and mortar stores to obtain a more accurate comparison of customers' purchasing behavior over time.

### BRIEF DESCRIPTION

In one embodiment, a method for determining sales migration between merchant types using a payment card network includes storing in a memory device, financial transaction data records for a plurality of purchase transactions conducted between a plurality of merchants and a plurality of payment card cardholders over a predetermined period of time. Each of the financial transaction data records including a cardholder account number and a merchant identifier that identifies a store type for the merchant as being one of an online store or a physical store. The method further includes determining a geographic home purchasing location of at least some of the plurality of the payment card cardholders using a respective cardholder account number and determining a geographic location of at least some of the plurality of merchants using a respective merchant identifier. The method also includes determining a trend of purchases from selected geographic home purchasing locations in relation to selected merchant identifiers and outputting the determined trends.

In another embodiment, a computer system for determining sales migration between merchant types using a payment card network includes a memory device and a processor in communication with the memory device wherein the processor is programmed to store financial transaction data records for a plurality of purchase transactions conducted between a plurality of merchants and a plurality of payment card cardholders over a predetermined period of time, each of the financial transaction data records including a cardholder account number and a merchant identifier that identifies a store type for the merchant as being one of an online store or a physical store. The processor is further programmed to determine a geographic home purchasing location of at least some of the plurality of the payment card cardholders using a respective cardholder account number and determine a geographic location of at least some of the plurality of merchants using a respective merchant identifier. The processor is also programmed to determine a trend of purchases from selected geographic home purchasing locations in relation to selected merchant identifiers and output the determined trends.

In yet another embodiment, one or more non-transitory computer-readable storage media has computer-executable instructions embodied thereon, wherein when executed by at least one processor, the computer-executable instructions cause the processor to store financial transaction data records for a plurality of purchase transactions conducted between a plurality of merchants and a plurality of payment card cardholders over a predetermined period of time, each of the financial transaction data records including a cardholder account number and a merchant identifier that identifies a store type for the merchant as being one of an online store or a physical store. The computer-executable instructions further cause the processor to determine a geographic home purchasing location of at least some of the plurality of the payment card cardholders using a respective cardholder account number and determine a geographic location of at least some of the plurality of merchants using a respective merchant identifier. The computer-executable instructions also cause the processor to determine a trend of purchases from selected geographic home purchasing locations in relation to selected merchant identifiers and output the determined trends.

### BRIEF DESCRIPTION OF THE DRAWINGS

FIGS. 1-12 show example embodiments of the methods and systems described herein.

FIG. 1 is a schematic diagram illustrating an example multi-party payment card processing system for enabling ordinary payment-by-card transactions in which merchants and card issuers do not necessarily have a one-to-one relationship.

FIG. 2 is a simplified block diagram of an example payment processing system including a plurality of computer devices, including a sales migration computing device, in accordance with one example embodiment of the present disclosure.

FIG. 3 is an expanded block diagram of an example embodiment of a server architecture of the payment processing system shown in FIG. 2 including the plurality of computer devices.

FIG. 4 illustrates an example configuration of a client system shown in FIGS. 2 and 3.

FIG. 5 illustrates an example configuration of a server system shown in FIGS. 2 and 3.

FIG. 6 is a data flow diagram of the sales migration system shown in FIG. 1 of the payment card processing system also shown in FIG. 1.

FIG. 7 is a flow diagram of a method of determining sales migration between merchant types using the payment card network shown in FIG. 1.

FIGS. 8-12 are graphs illustrating various example correlations of online store sales versus brick and mortar store sales.

### DETAILED DESCRIPTION

Embodiments of the methods and systems described herein relate to determining sales migration between merchant types by deaggregating cardholder information of cardholders that make purchases at large online retailers' websites using payment cards over a payment card network. Currently, cardholders that use payment cards to make purchases at large online retailers cause the financial transaction data to appear to be attributable to a cardholder making a purchase in the location of the online retailer headquarters or processing facility. Such an appearance tends to skew the information. For example, a cardholder, whose geographic home purchasing location is located in a location such as Indianapolis, Ind., who makes an online purchase at a large online retailer, for example, Amazon.com®, will appear to be making the purchase in Seattle, Wash., where Amazon.com® is headquartered. By attributing the purchases made at large online retailers websites to the cardholders' geographic home purchasing location, migration data between brick and mortar and online stores can be more easily determined and made available. A cardholder's geographic home purchasing location may be inferred from the location of merchants a cardholder makes purchases from. The inference may be adjusted by various correction factors that take into account for example, purchases at online retailers.

As used herein, the terms “transaction card,” “financial transaction card,” and “payment card” refer to any suitable payment card, such as a credit card, a debit card, a prepaid card, a charge card, a membership card, a promotional card, a frequent flyer card, an identification card, a prepaid card, a gift card, and/or any other device that may hold payment account information, such as mobile phones, smartphones, personal digital assistants (PDAs), key fobs, and/or computers. Each type of transactions card can be used as a method of payment for performing a transaction.

In one embodiment, a computer program is provided, and the program is embodied on a computer readable medium. In an example embodiment, the system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The following detailed description illustrates embodiments of the disclosure by way of example and not by way of limitation. It is contemplated that the disclosure has general application to processing financial transaction data by a third party in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

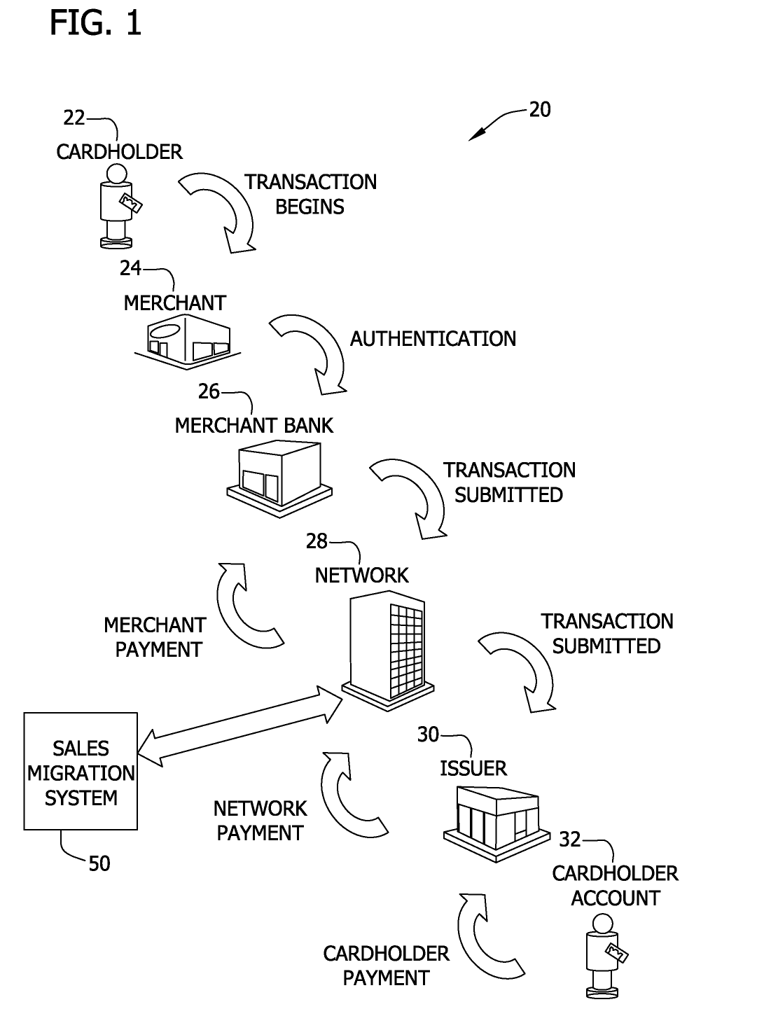

FIG. 1 is a schematic diagram illustrating an example multi-party payment card processing system 20 for enabling payment-by-card transactions in which merchants 24 and card issuers 30 do not need to have a one-to-one special relationship. Embodiments described herein may relate to a payment card system, such as a payment card network operated by MasterCard International Incorporated. The payment card network, as described herein, is a four-party payment card network that includes a plurality of special purpose processors and data structures stored in one or more memory devices communicatively coupled to the processors, and a set of proprietary communications standards promulgated by MasterCard International Incorporated for the exchange of financial transaction data and the settlement of funds between financial institutions that are members of the payment card network.

In a payment card system, a financial institution called the “issuer” issues a payment card, such as a credit card, to a consumer or cardholder 22, who uses the payment card to tender payment for a purchase from a merchant 24. To accept payment with the payment card, merchant 24 must normally establish an account with a financial institution that is part of the financial payment processing system. This financial institution is usually called the “merchant bank,” the “acquiring bank,” or the “acquirer.” When cardholder 22 tenders payment for a purchase with a payment card, merchant 24 requests authorization from a merchant bank 26 for the amount of the purchase. The request may be performed over the telephone, but is usually performed through the use of a point-of-sale terminal, which reads cardholder's 22 account information from a magnetic stripe, a chip, or embossed characters on the payment card and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using a payment card network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

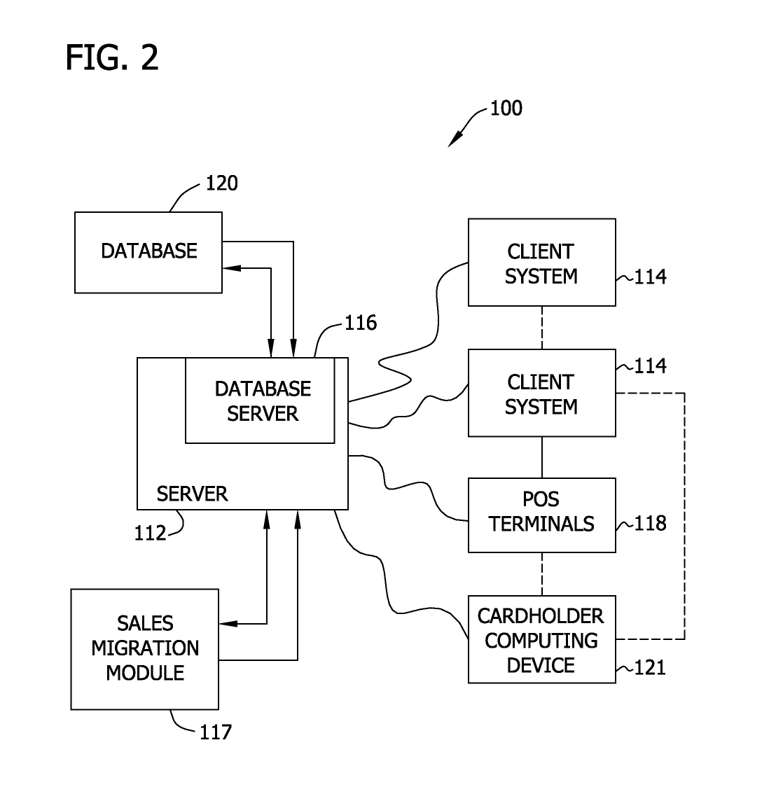

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns goods after the transaction has been captured, a “credit” is generated. Payment card network 28 and/or issuer bank 30 stores the payment card information, such as a type of merchant, amount of purchase, date of purchase, in a database 120 (shown in FIG. 2).

For debit card transactions, when a request for a PIN authorization is approved by the issuer, the consumer's account is decreased. Normally, a charge is posted immediately to a consumer's account. The issuer 30 then transmits the approval to the merchant bank 26 via the payment network 28, with ultimately the merchant 24 being notified for distribution of goods/services, or information or cash in the case of an ATM.

After a purchase has been made, a clearing process occurs to transfer additional transaction data related to the purchase among the parties to the transaction, such as merchant bank 26, payment card network 28, and issuer bank 30. More specifically, during and/or after the clearing process, additional data, such as a time of purchase, a merchant name, a type of merchant, purchase information, cardholder account information, a type of transaction, geographic home purchasing location, information regarding the purchased item and/or service, and/or other suitable information, is associated with a transaction and transmitted between parties to the transaction as transaction data, and may be stored by any of the parties to the transaction. In the example embodiment, when cardholder 22 purchases products at a brick and mortar store or an online store zip code or geographic home purchasing location is transmitted during the clearance process as transaction data. When payment card network 28 receives the location information, payment card network 28 routes the location information to database 120.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and payment card network 28, and then between payment card network 28 and merchant bank 26, and then between merchant bank 26 and merchant 24.

Payment card sales migration system 50 communicates with network 28 to receive financial transaction data for a plurality of transactions performed over a predetermined time period. Payment card sales migration system 50 deaggregates transactions that occur at online stores so that the geographic home purchasing location of the cardholder is accurately reflected for analysis of a migration of sales from brick and mortar type stores to online stores. Currently, all sales made online, appear as being conducted in the geographic location of, for example, a headquarters location of the online store. To make logical comparisons of financial transaction data for a determination of sales migration, the financial transaction data is normalized to the geographic home purchasing location of each cardholder for each transaction.

FIG. 2 is a simplified block diagram of an example processing system 100 including a plurality of computer devices, such as server system 112, client systems 114, sales migration module 117, and cardholder computing device 121 in accordance with one embodiment of the present disclosure. In one embodiment payment system 100 implements a process to validate a payment card transaction. More specifically, sales migration module 117 in communication with server system 112 is configured to receive financial transaction data records for a plurality of purchase transactions conducted between a plurality of merchants and a plurality of payment card cardholders over a predetermined period of time, each of the financial transaction data records including a cardholder account number and a merchant identifier that identifies a store type for the merchant as being one of an online store or a physical store. Sales migration module 117 is also configured to determine a geographic home purchasing location of at least some of the plurality of the payment card cardholders using a respective cardholder account number and determine a geographic location of at least some of the plurality of merchants using a respective merchant identifier. Sales migration module 117 is further configured to determine a trend of purchases from selected geographic home purchasing locations in relation to selected merchant identifiers and to output the determined trends.

In the example embodiment, system 100 may be used for performing payment-by-card transactions and/or determining sales migration between merchant types using data received as of part of processing the financial transaction. For example, system 100 may store a merchant type in a merchant database along with for example, merchant location data. The location data may include, for example, a street name, a street number, a unit number, a unit name, a street direction, a street suffix, a street number prefix, and/or a floor number. The location data may include latitude and longitude, or other coordinate system coordinates. System 100 may receive location data as part of processing transactions. System 100 is configured to process financial transaction data and convert the cardholders' aggregated location to a geographic home purchasing location for each cardholder. The converted location data can then be compared to geographic location data from brick and mortar stores stored in a merchant database, such as database 120. Using the converted location data, the cardholders' geographic home purchasing location, and brick and mortar store locations, system 100 is configured to determine sales migration between merchant types.

More specifically, in the example embodiment, system 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems, and special high-speed Integrated Services Digital Network (ISDN) lines. Client systems 114 could be any device capable of interconnecting to the Internet including a web-based phone, PDA, or other web-based connectable equipment.

System 100 also includes point-of-sale (POS) terminals 118, which may be connected to client systems 114 and may be connected to server system 112. POS terminals 118 are interconnected to the Internet through many interfaces including a network, such as a local area network (LAN) or a wide area network (WAN), dial-in-connections, cable modems, wireless modems, and special high-speed ISDN lines. POS terminals 118 could be any device capable of interconnecting to the Internet and including an input device capable of reading information from a consumer's financial payment card.

A database server 116 is connected to database 120, which contains information on a variety of matters, as described below in greater detail. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized.

Database 120 may include a single database having separated sections or partitions or may include multiple databases, each being separate from each other. Database 120 may store transaction data generated as part of sales activities conducted over the processing network including data relating to merchants, account holders or customers, issuers, acquirers, purchases made. Database 120 may also store account data including at least one of a cardholder name, a cardholder address, a primary account number (PAN) associated with the cardholder name, and other account identifier. Database 120 may also store merchant data including a merchant identifier that identifies each merchant registered to use the network, and instructions for settling transactions including merchant bank account information. Database 120 may also store purchase data associated with items being purchased by a cardholder from a merchant, and authorization request data. Database 120 may store raw address data, formatted address data, standardized address data, and/or standard address data associated with a customer, an online merchant, and/or a brick and mortar merchant, for processing according to the method described in the present disclosure.

In the example embodiment, one of client systems 114 may be associated with acquirer bank 26 (shown in FIG. 1) while another one of client systems 114 may be associated with issuer bank 30 (shown in FIG. 1). POS terminal 118 may be associated with a participating merchant 24 (shown in FIG. 1) or may be a computer system and/or mobile system used by a cardholder making an on-line purchase or payment. Server system 112 may be associated with payment card network 28. In the example embodiment, server system 112 is associated with a financial transaction processing network, such as payment card network 28, and may be referred to as an interchange computer system. Server system 112 may be used for processing transaction data. In addition, client systems 114 and/or POS 118 may include a computer system associated with at least one of an online bank, a bill payment outsourcer, an acquirer bank, an acquirer processor, an issuer bank associated with a payment card, an issuer processor, a remote payment processing system, a biller, and/or a sales migration system. The sales migration system may be associated with payment card network 28 or with an outside third party in a contractual relationship with payment card network 28. Accordingly, each party involved in processing transaction data are associated with a computer system shown in system 100 such that the parties can communicate with one another as described herein.

Using payment card network 28, the computers of the merchant bank or the merchant processor communicate with the computers of the issuer bank to determine whether the consumer's account is in good standing and whether the purchase is covered by the consumer's available credit line. Based on these determinations, the request for authorization will be declined or accepted. If the request is accepted, an authorization code is issued to the merchant.

When a request for authorization is accepted, the available credit line of consumer's account is decreased. Normally, a charge is not posted immediately to a consumer's account because bankcard associations, such as MasterCard International Incorporated®, have promulgated rules that do not allow a merchant to charge, or “capture,” a transaction until goods are shipped or services are delivered. When a merchant ships or delivers the goods or services, the merchant captures the transaction by, for example, appropriate data entry procedures on the point-of-sale terminal. If a consumer cancels a transaction before it is captured, a “void” is generated. If a consumer returns goods after the transaction has been captured, a “credit” is generated.

For debit card transactions, when a request for a PIN authorization is approved by the issuer, the consumer's account is decreased. Normally, a charge is posted immediately to a consumer's account. The bankcard association then transmits the approval to the acquiring processor for distribution of goods/services, or information or cash in the case of an ATM.

After a transaction is captured, the transaction is settled between the merchant, the merchant bank, and the issuer. Settlement refers to the transfer of financial data or funds between the merchant's account, the merchant bank, and the issuer related to the transaction. Usually, transactions are captured and accumulated into a “batch,” which is settled as a group.

The financial payment cards discussed herein may include credit cards, debit cards, a charge card, a membership card, a promotional card, prepaid cards, and gift cards. These cards can all be used as a method of payment for performing a transaction. As described herein, the term “payment card” includes cards such as credit cards, debit cards, and prepaid cards, but also includes any other devices that may hold payment account information, such as mobile phones, personal digital assistants (PDAs), key fobs, or other devices, etc.

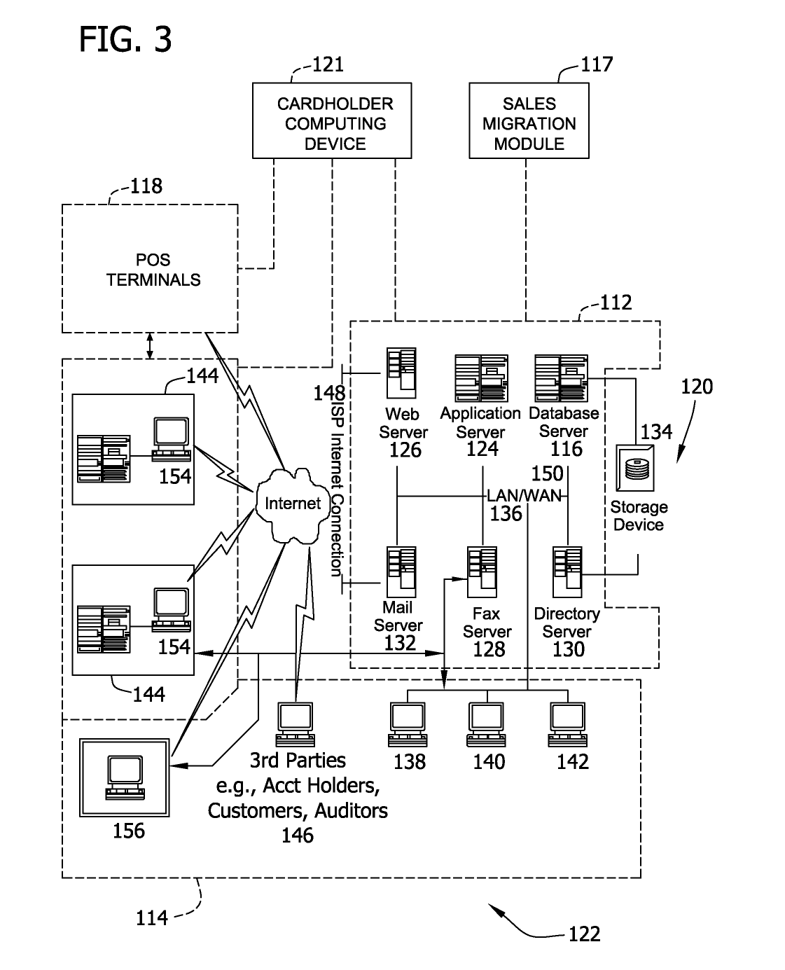

FIG. 3 is an expanded block diagram of an example embodiment of a server architecture of a payment processing system 122 including other computer devices such as, sales migration computer device 117. Components in system 122, identical to components of system 100 (shown in FIG. 2), are identified in FIG. 3 using the same reference numerals as used in FIG. 2. System 122 includes server system 112, client systems 114, sales migration module 117, and POS terminals 118. Server system 112 further includes database server 116, a transaction server 124, a web server 126, a fax server 128, a directory server 130, and a mail server 132. A storage device 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., account holders, customers, auditors, developers, consumers, merchants, acquirers, issuers, etc., 146 using an ISP Internet connection 148. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the example embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

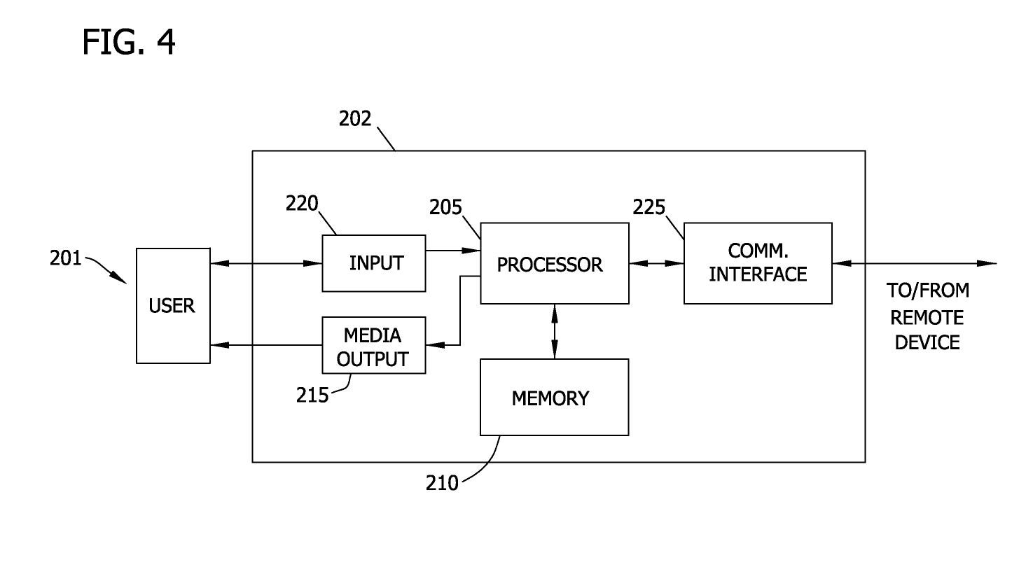

FIG. 4 illustrates an example configuration of a user system 202 operated by a user 201, such as cardholder 22 (shown in FIG. 1). User system 202 may include, but is not limited to, client systems 114, 138, 140, and 142, POS terminal 118, workstation 154, and manager workstation 156. In the example embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively couplable to a remote device such as server system 112. Communication interface 225 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server system 112. A client application allows user 201 to interact with a server application from server system 112.

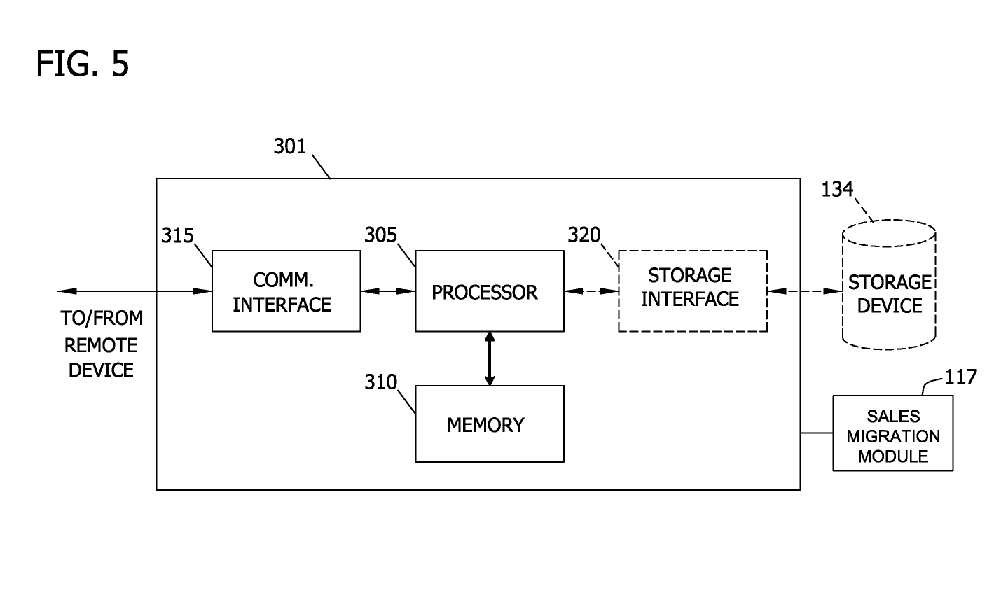

FIG. 5 illustrates an example configuration of a server system 301 such as server system 112 (shown in FIGS. 2 and 3). Server system 301 may include, but is not limited to, database server 116, transaction server 124, web server 126, fax server 128, directory server 130, and mail server 132.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc).

Server system 301 may be communicatively coupled to sales migration module 117. Sales migration module 117 is in communication with server system 112 and is configured to receive financial transaction data in connection with payment transactions, wherein each of the financial transaction data records includes a cardholder account number and a merchant identifier that identifies a store type for the merchant as being one of an online store or a physical store. Sales migration module 117 is also configured to determine a geographic home purchasing location of at least some of the plurality of the payment card cardholders associated with the financial transaction data using a respective cardholder account number. Sales migration module 117 is also configured to determine a geographic location of at least some of the plurality of merchants using a respective merchant identifier and to determine a trend of purchases from selected geographic home purchasing locations in relation to selected merchant identifiers. In the example embodiment, sales migration module 117 may be external to server system 301 and may be accessed by multiple server systems 301. For example, sales migration module 117 may be a computing device coupled to a memory unit. In some embodiments, sales migration module 117 may be integrated with server system 301. For example, sales migration module 117 may be a specifically programmed section of server system 301 configured to perform the functions described herein when executed by processor 305.

Processor 305 is operatively coupled to a communication interface 315 such that server system 301 is capable of communicating with a remote device such as a user system or another server system 301. For example, communication interface 315 may receive requests from user system 114 via the Internet, as illustrated in FIGS. 2 and 3.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

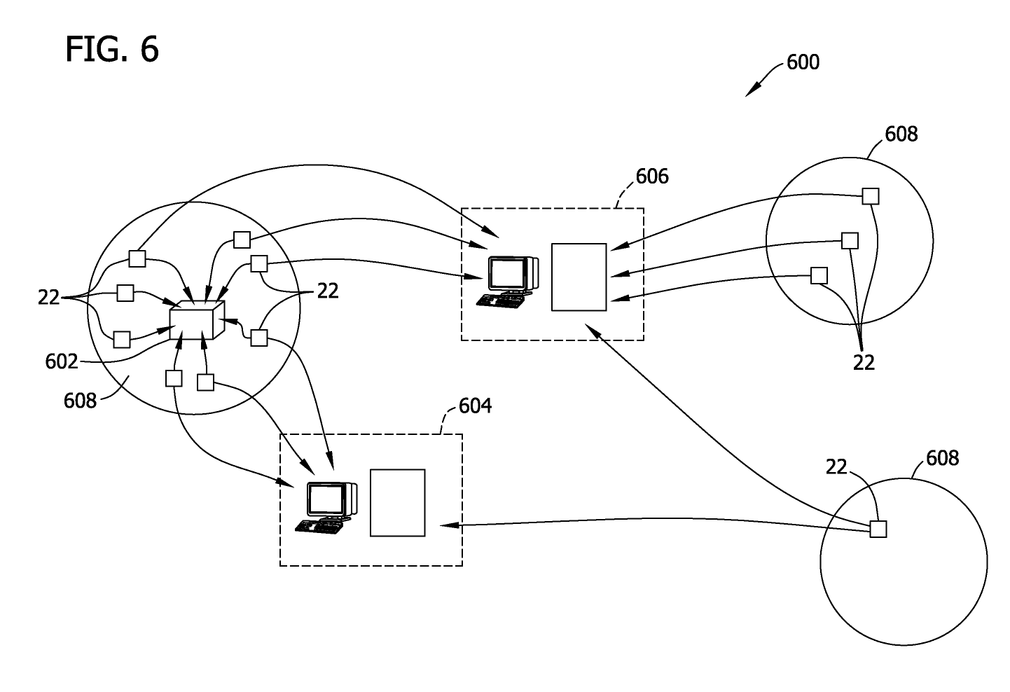

FIG. 6 is a data flow diagram of payment card sales migration system 50 included within payment card processing system 20 for illustrating purchases made by payment card cardholders 22 at a brick and mortar store 602 associated with a retailer, an online store 604 associated with the retailer, and an online store 606, which may be an online only store that is not associated with any brick and mortar stores. Cardholders 22 may be associated with geographic home purchasing locations 608, which may be inferred from each cardholder's 22 purchasing history or may be known from data acquired from cardholder 22 or some other data source. Cardholders 22 typically exhibit a purchasing behavior that includes some mix of purchasing at brick and mortar stores 602, online stores 604, and online stores 606. Additionally, each cardholder 22 has various other choices for purchasing that are not illustrated in FIG. 1 for clarity. The purchasing behavior of each cardholder 22 may evolve over time due to various trends. For example, social shopping excursions are typically performed by groups of people at brick and mortar stores 602 and may not be impacted significantly by sales or discounts promoted by online stores. Other price sensitive purchases may be performed by individuals almost exclusively at online stores 606, where price comparison shopping is relatively easy. Trends between online shopping and brick and mortar store shopping may vary over time, including seasonal trends, and trends relating to technology improvements that make either online or brick and mortar store shopping easier for a greater number of cardholders 22. Determining such trends may be accomplished by deaggregating the online store purchases to the geographic home purchasing locations of the cardholders making those purchases.

In various embodiments, system 50 receives transaction data for a plurality of transactions for a predetermined period of time. The transaction data is received from payment card network 20. The transaction data includes at least the merchant identifier for merchant 24 where each transaction took place and a primary account number of cardholder 22. System 50 determines if merchant 24 is an online merchant based on the received merchant identifier. System 50 also determines the geographic home purchasing location for cardholder 22 if merchant 24 is an online merchant. The geographic home purchasing location can be inferred from the location of purchases made by cardholder 22. The geographic home purchasing location of cardholder 22 can be associated with each respective transaction so that instead of being attributed to the location of online stores 604 and 606, the transaction will be attributed to the geographic home purchasing location of cardholder 22.

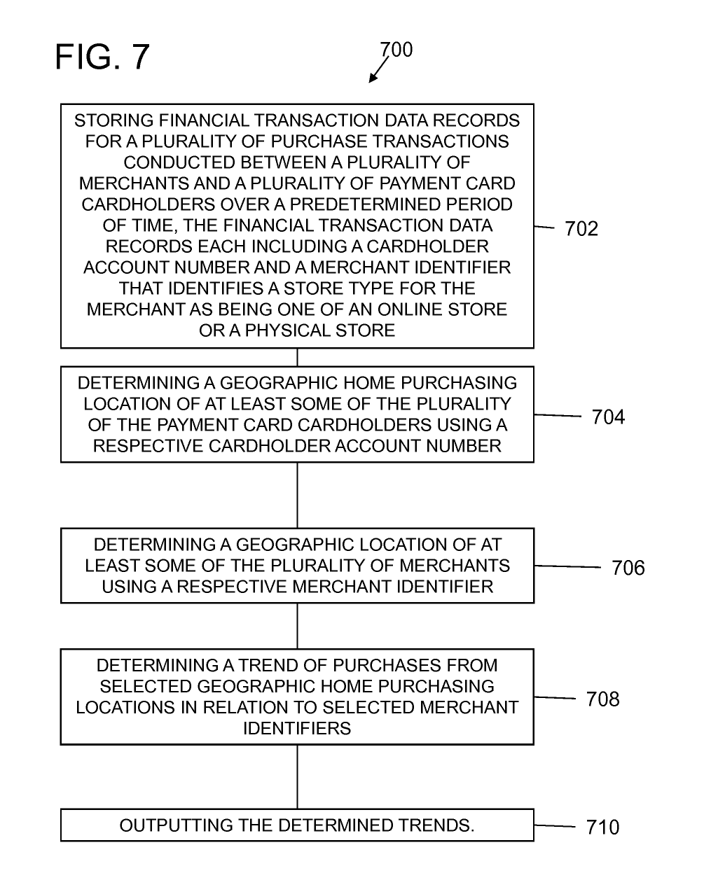

FIG. 7 is a flow diagram of a method 700 of determining sales migration between merchant types using payment card network 20. In the example embodiment, method 700 is implemented using a computer device coupled to a memory device. As used herein, sales migration refers to cardholders 22 switching the merchant from whom cardholder 22 purchases goods from brick and mortar stores 602 to online stores 604, 608. Method 700 includes storing 702 in the memory device, financial transaction data records for a plurality of purchase transactions conducted between a plurality of merchants 24 and a plurality of payment card cardholders 22 over a predetermined period of time. The stored financial transaction data records are historical records of past purchases up to and including current financial transaction data records updated in real-time or at predetermined intervals. Each of the financial transaction data records including a cardholder account number and a merchant identifier that identifies a store type for the merchant as being one of an online store or a physical store.

Method 700 includes determining 704 geographic home purchasing location 608 of at least some of the plurality of the payment card cardholders 22 using a respective cardholder account number and determining 706 a geographic location of at least some of the plurality of merchants using a respective one the received merchant identifiers. Method 700 further includes determining 708 a trend of purchases from selected geographic home purchasing locations in relation to selected merchant identifiers and outputting 710 the determined trends.

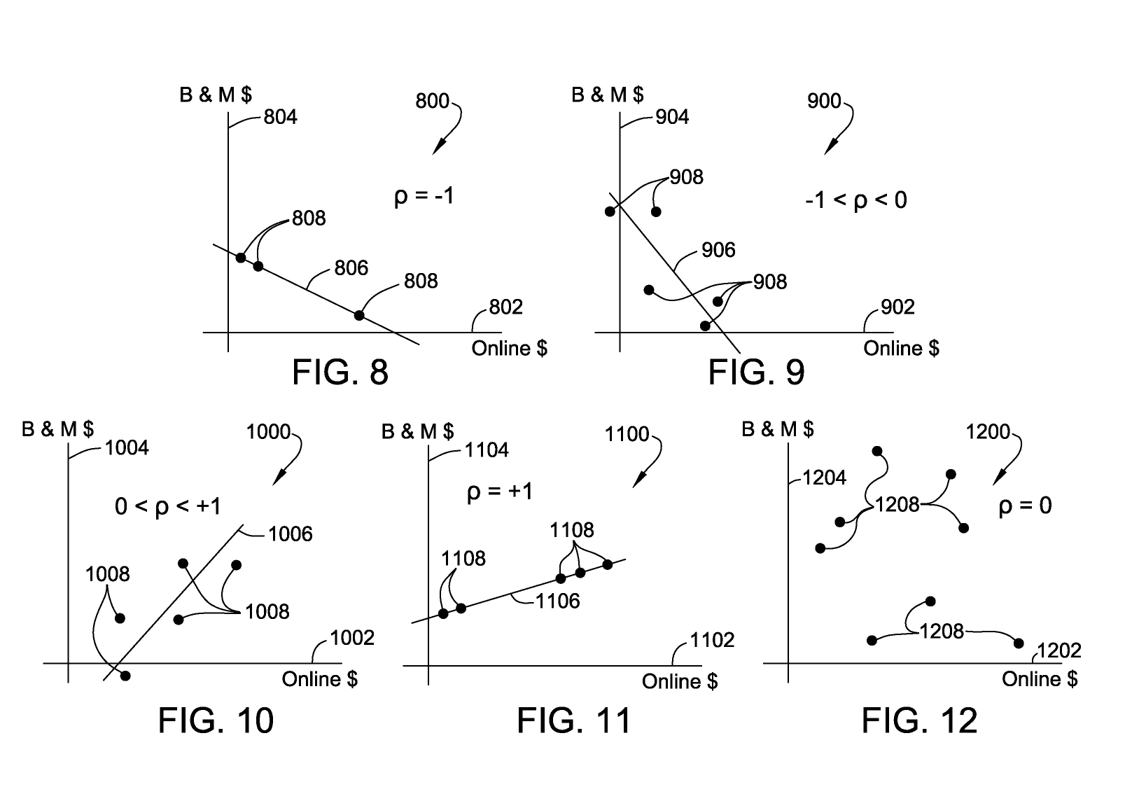

FIG. 8 is a graph of a correlation of online store sales versus brick and mortar store sales. Graph 800 includes an x-axis 802 graduated in units of a currency for online store sales. In this embodiment, the currency is dollars. Graph 800 includes a y-axis 804 graduated in units of the currency. A trace 806 illustrates a curve fit of a plurality of data points 808. Data points 808 represent a trend of online store sales versus brick and mortar store sales over time, where each data point 808 represents online store sales versus brick and mortar store sales at a particular time or over a particular time period, for example, one week, or one buying season. The online store sales and brick and mortar store sales are normalized to comparable geographic proximities. For example, the apparent location of online store sales may be a headquarters location for the online store, therefore these sales are de-aggregated to reflect the actual geographic proximity of the purchaser.

The illustrated scenario, where correlation (ρ) equals approximately −1, implies that online store sales are strongly inversely related to brick and mortar store sales, (i.e., the more online sales, the less brick and mortar sales and vice versa).

FIG. 9 is another graph of a correlation of online store sales versus brick and mortar store sales. Graph 900 includes an x-axis 902 graduated in units of a currency for online store sales. In this embodiment, the currency is dollars. Graph 900 includes a y-axis 904 graduated in units of the currency. A trace 906 illustrates a curve fit of a plurality of data points 908. Data points 908 represent a trend of online store sales versus brick and mortar store sales over time, where each data point 908 represents online store sales versus brick and mortar store sales at a particular time or over a particular time period, for example, one week, or one buying season. The online store sales and brick and mortar store sales are normalized to comparable geographic proximities. For example, the apparent location of online store sales may be a headquarters location for the online store, therefore these sales are de-aggregated to reflect the actual geographic proximity of the purchaser.

The illustrated scenario, where correlation (ρ) is between −1 and 0, implies that online store sales are moderately inversely related to brick and mortar store sales, not as pronounced as the scenario shown in FIG. 8.

FIG. 10 is another graph of a correlation of online store sales versus brick and mortar store sales. Graph 1000 includes an x-axis 1002 graduated in units of a currency for online store sales. In this embodiment, the currency is dollars. Graph 1000 includes a y-axis 1004 graduated in units of the currency. A trace 1006 illustrates a curve fit of a plurality of data points 1008. Data points 1008 represent a trend of online store sales versus brick and mortar store sales over time, where each data point 1008 represents online store sales versus brick and mortar store sales at a particular time or over a particular time period, for example, one week, or one buying season. The online store sales and brick and mortar store sales are normalized to comparable geographic proximities. For example, the apparent location of online store sales may be a headquarters location for the online store, therefore these sales are de-aggregated to reflect the actual geographic proximity of the purchaser.

The illustrated scenario, where correlation (ρ) is between 0 and 1, implies that online store sales are moderately directly related to brick and mortar sales.

FIG. 11 is another graph of a correlation of online store sales versus brick and mortar store sales. Graph 1100 includes an x-axis 1102 graduated in units of a currency for online store sales. In this embodiment, the currency is dollars. Graph 1100 includes a y-axis 1104 graduated in units of the currency. A trace 1106 illustrates a curve fit of a plurality of data points 1108. Data points 1108 represent a trend of online store sales versus brick and mortar store sales over time, where each data point 1108 represents online store sales versus brick and mortar store sales at a particular time or over a particular time period, for example, one week, or one buying season. The online store sales and brick and mortar store sales are normalized to comparable geographic proximities. For example, the apparent location of online store sales may be a headquarters location for the online store, therefore these sales are de-aggregated to reflect the actual geographic proximity of the purchaser.

The illustrated scenario, where correlation (ρ) equals approximately 1, implies that both online store sales versus brick and mortar store sales are growing at the same rates.

FIG. 12 is another graph of a correlation of online store sales versus brick and mortar store sales. Graph 1200 includes an x-axis 1202 graduated in units of a currency for online store sales. In this embodiment, the currency is dollars. Graph 1200 includes a y-axis 1204 graduated in units of the currency. Data points 1208 represent a trend of online store sales versus brick and mortar store sales over time, where each data point 1208 represents online store sales versus brick and mortar store sales at a particular time or over a particular time period, for example, one week, or one buying season. The online store sales and brick and mortar store sales are normalized to comparable geographic proximities. For example, the apparent location of online store sales may be a headquarters location for the online store, therefore these sales are de-aggregated to reflect the actual geographic proximity of the purchaser.

The illustrated scenario, where correlation (ρ) equals approximately 0, suggests that there is no noticeable relationship between the online store sales versus brick and mortar store sales.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by mobile devices, clusters, personal computers, workstations, clients, servers, and processor 205,305 wherein the memory includes RAM memory, ROM memory, EPROM memory, EEPROM memory, and non-volatile RAM (NVRAM) memory. The above memory types are examples only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the disclosure. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network. The technical effect of the methods and systems may be achieved by performing at least one of the following steps: (a) storing in the memory device, financial transaction data records for a plurality of purchase transactions conducted between a plurality of merchants and a plurality of payment card cardholders over a predetermined period of time, each of the financial transaction data records including a cardholder account number and a merchant identifier that identifies a store type for the merchant as being one of an online store or a physical store, (b) determining a geographic home purchasing location of at least some of the plurality of the payment card cardholders using a respective cardholder account number, (c) determine a geographic location of at least some of the plurality of merchants using a respective merchant identifier, (d) determine a trend of purchases from selected geographic home purchasing locations in relation to selected merchant identifiers, and (e) outputting the determined trends.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “computer” and related terms, e.g., “computing device”, are not limited to integrated circuits referred to in the art as a computer, but broadly refers to a microcontroller, a microcomputer, a programmable logic controller (PLC), an application specific integrated circuit, and other programmable circuits, and these terms are used interchangeably herein.

As used herein, the term “cloud computing” and related terms, e.g., “cloud computing devices” refers to a computer architecture allowing for the use of multiple heterogeneous computing devices for data storage, retrieval, and processing. The heterogeneous computing devices may use a common network or a plurality of networks so that some computing devices are in networked communication with one another over a common network but not all computing devices. In other words, a plurality of networks may be used in order to facilitate the communication between and coordination of all computing devices.

As used herein, the term “mobile computing device” refers to any of computing device which is used in a portable manner including, without limitation, smart phones, personal digital assistants (“PDAs”), computer tablets, hybrid phone/computer tablets (“phablet”), or other similar mobile device capable of functioning in the systems described herein. In some examples, mobile computing devices may include a variety of peripherals and accessories including, without limitation, microphones, speakers, keyboards, touchscreens, gyroscopes, accelerometers, and metrological devices. Also, as used herein, “portable computing device” and “mobile computing device” may be used interchangeably.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

The above-described embodiments of a method and system of determining sales migration trends between brick and mortar stores and online stores provides a cost-effective and reliable means for providing an analytical framework for facilitating business decision-making. More specifically, the methods and systems described herein facilitate correlating purchase transactions of a plurality of payment card cardholders at online stores to their respective geographic home purchasing area. In addition, the above-described methods and systems facilitate comparing changes in purchasing transactions over predetermined periods of time. As a result, the methods and systems described herein facilitate determining a migration of payment card cardholders from brick and mortar stores to online stores in cardholders' geographic home purchasing area in a cost-effective and reliable manner.

This written description uses examples to describe the disclosure, including the best mode, and also to enable any person skilled in the art to practice the disclosure, including making and using any devices or systems and performing any incorporated methods. The patentable scope of the application is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented method for determining sales migration between merchant types using a payment card network, the method implemented using a computer device coupled to a memory device, the method comprising:
storing in the memory device, financial transaction data records for a plurality of purchase transactions conducted between a plurality of merchants and a plurality of payment card cardholders over a predetermined period of time, each of the financial transaction data records including a cardholder account number and a merchant identifier that identifies a store type for the merchant as being one of an online store or a physical store;
determining a geographic home purchasing location of at least some of the plurality of the payment card cardholders using a respective cardholder account number;
determining a geographic location of at least some of the plurality of merchants using a respective merchant identifier;
determining a trend of purchases from selected geographic home purchasing locations in relation to selected merchant identifiers; and
outputting the determined trends.

2. The computer-implemented method of claim 1, wherein determining a geographic home purchasing location comprises determining a geographic home purchasing location using a location inferred from purchasing locations of historical transactions.

3. The computer-implemented method of claim 1, wherein at least some of the plurality of merchants are associated with a physical store having a first merchant identifier and an online store having a second merchant identifier.

4. The computer-implemented method of claim 3, wherein the first merchant identifier and the second merchant identifier linked such that the physical store and online store of the same merchant can be treated as a single entity.

5. The computer-implemented method of claim 1, further comprising ranking physical store associated with the same merchant by sales.

6. The computer-implemented method of claim 1, further comprising determining the geographic home purchasing locations of the plurality of the payment card cardholders for the plurality of merchants.

7. The computer-implemented method of claim 1, wherein determining a geographic home purchasing location of at least some of the plurality of the payment card cardholders using a respective cardholder account number comprises accessing at least one of a database that includes cardholder account numbers associated with inferred geographic home purchasing location based on a transaction history of the cardholder and a database that includes cardholder account numbers associated with determined geographic areas.

8. A computer system for determining sales migration between merchant types using a payment card network, the computer system comprising a memory device and a processor in communication with the memory device, the processor programmed to:
store financial transaction data records for a plurality of purchase transactions conducted between a plurality of merchants and a plurality of payment card cardholders over a predetermined period of time, each of the financial transaction data records including a cardholder account number and a merchant identifier that identifies a store type for the merchant as being one of an online store or a physical store;
determine a geographic home purchasing location of at least some of the plurality of the payment card cardholders using a respective cardholder account number;
determine a geographic location of at least some of the plurality of merchants using a respective merchant identifier;
determine a trend of purchases from selected geographic home purchasing locations in relation to selected merchant identifiers; and
output the determined trends.

9. The computer system of claim 8, wherein said processor is further programmed to determine a geographic home purchasing location using a location inferred from purchasing locations of historical transactions.

10. The computer system of claim 8, wherein at least some of the plurality of merchants are associated with a physical store having a first merchant identifier and an online store having a second merchant identifier.

11. The computer-implemented method of claim 10, wherein the first merchant identifier and the second merchant identifier are linked such that the physical store and online store of the same merchant can be treated as a single entity.

12. The computer system of claim 8, wherein said processor is further programmed to rank physical stores associated with the same merchant by sales using the financial transaction data records.

13. The computer system of claim 8, wherein said processor is further programmed to determine the geographic home purchasing locations of the plurality of the payment card cardholders for the plurality of merchants.

14. The computer system of claim 8, wherein said processor is further programmed to access at least one of a database that includes cardholder account numbers associated with inferred geographic home purchasing location based on a transaction history of the cardholder and a database that includes cardholder account numbers associated with determined geographic areas.

15. One or more non-transitory computer-readable storage media having computer-executable instructions embodied thereon, wherein when executed by at least one processor, the computer-executable instructions cause the processor to:
store financial transaction data records for a plurality of purchase transactions conducted between a plurality of merchants and a plurality of payment card cardholders over a predetermined period of time, each of the financial transaction data records including a cardholder account number and a merchant identifier that identifies a store type for the merchant as being one of an online store or a physical store;
determine a geographic home purchasing location of at least some of the plurality of the payment card cardholders using a respective cardholder account number;
determine a geographic location of at least some of the plurality of merchants using a respective merchant identifier;
determine a trend of purchases from selected geographic home purchasing locations in relation to selected merchant identifiers; and
output the determined trends.

16. The computer-readable storage media of claim 15, wherein determining a geographic home purchasing location comprises determining a geographic home purchasing location using a location inferred from purchasing locations of historical transactions.

17. The computer-readable storage media of claim 15, wherein at least some of the plurality of merchants are associated with a physical store having a first merchant identifier and an online store having a second merchant identifier.

18. The computer-readable storage media of claim 17, wherein the first merchant identifier and the second merchant identifier linked such that the physical store and online store of the same merchant can be treated as a single entity.

19. The computer-readable storage media of claim 15, further comprising ranking physical store associated with the same merchant by sales.

20. The computer-readable storage media of claim 15, further comprising determining the geographic home purchasing locations of the plurality of the payment card cardholders for the plurality of merchants.
